(19) United States
(12) Patent Application Publication
(10) Pub. No.: US 2016/0055430 A1
(43) Pub. Date: Feb. 25, 2016

(54) Social Networking Enhanced System for Review and Sale of Music and Venue-Related Products and Services

(71) Applicant: Heesham Naji, Irvine, CA (US)

(72) Inventor: Heesham Naji, Irvine, CA (US)

(21) Appl. No.: 14/831,760

(22) Filed: Aug. 20, 2015

Related U.S. Application Data
(60) Provisional application No. 62/039,813, filed on Aug. 20, 2014.

(51) Int. Cl. G06Q 10/02; G06Q 30/06; G06Q 30/02; G06Q 50/00

(52) U.S. Cl. CPC G06Q 10/02; G06Q 50/01; G06Q 30/0601; G06Q 30/0252

(57) ABSTRACT

A software enabled system and method for subscriber social networking, review input, and purchases is provided allowing subscribers to input identification information, interests, and contact information for friends. Ticket purchases for future events from subscribers are communicated to identified friends who may purchase tickets to the same event. Reviews of events and venues are provided to subscribers and may only be input by subscribers verified as having attended the event or venue.

This application claims priority to U.S. Provisional Application No. 62/039,813 filed on Aug. 20, 2014, which is incorporated herein in its entirety, by this reference thereto.

### FIELD OF THE INVENTION

The disclosed system and method relate generally to a system employing a website and social networking for the sale of music venue related products. More particularly, it relates to a system for the selling of tickets to system subscribers to attend music related events, such as those featuring electronic dance music, which employs subscriber reviews and pushed-communications concerning such reviews and upcoming attendance at such music venues by subscribers, to other subscribing members of the system identified as related to the attending subscriber. Additionally provided can be related services for the traveling-attendee such as local ride share affiliates UBER, LYFT, and ZIPCAR and an encoded Loyalty Card employable as a ticket and for communications.

### BACKGROUND OF THE INVENTION

In the sale of concert tickets for musical performances and for attendance at music festivals and dance events and the like, conventionally, attendees must purchase their tickets to attend at the venue box office or by using an online service such as TICKETMASTER to purchase admittance to the desired event. However, this conventional system often may not be available for potential attendees of musical and dance events at smaller venues, such as dance clubs, or for concerts and the like where the performers are not well known, or for small or regional venues featuring live or recorded music for dancing or other artistic events.

Additionally, even where a small or local venue for dancing or concerts or other events does provide an online system for purchasing tickets, problems and shortcomings are conventionally present to persons seeking to buy tickets to attend a concert or visit a local venue having electronic dance music, local bands, and even headliners who are well known.

In the case of attendees for venues featuring dancing such as with electronic dance music, or DJ generated music, or even live performers, or other artistic events which draw a crowd, it is frequently hard for persons deciding whether to purchase tickets to attend, to discern reviews on the venue itself, or the dance music or other artistic endeavor to be provided. The success or perceived enjoyment by attendees at small venues featuring dancing using electronic or other music, or featuring a band or group providing such music, or featuring a local artistic show, is generally directly related to the number, and type of persons, who concurrently attending the same event with an attendee.

For example, an electronic dance event at a particular venue, should the crowd be sparse, or should the attendee encounter mostly strangers, may not be perceived as particularly enjoyable. Conversely, a dance event, or small musical event or show, where many of the attendees are friends, or persons who have a keen interest in the same type of music, may be perceived by attendees as highly enjoyable and something they would like to repeat and expand upon. As can be discerned, the difference in reviews of the venues and events, is more related to who attended with the attendee, rather than the quality of the venue or music or event.

With conventional ticket sites for events, be it the venue providing them, or a third party website or a ticket service, it is highly unlikely that potential ticket buyers will be able to ascertain if there are other attendees who are friends who plan to buy tickets for and attend a musical event or dance event. Further, if there are any reviews available on the venue, or the past crowds, or prior events, the majority of such third party ticket websites simply post the opinion or review without discerning the source or validity thereof. Consequently, such reviews may not be accurate, and potential ticket buyers are generally unable to ascertain if any such reviews were made by friends or acquaintances or other persons whom they consider knowledgeable or at least reliable.

In addition, upon purchasing a ticket for an event at a small local venue, event, or even a larger event, the attendee generally has a couple of choices for ticket delivery. They can either have it mailed, and hope it arrives in time, or they can pick it up at the venue, where they must stand in line to retrieve it. Should they fail to have the proper receipt, identification, or in many cases the actual credit card used to purchase the tickets, they will not be able to retrieve the tickets.

Additionally, in the conventional manner of event ticket sales and purchasing, there is no real encouragement for actual attendees at a venue or event, to subsequently provide a review or rating which will be available for future ticket purchasers. Conventionally, to post a review it requires the event or venue attendee, to log back into the third party system, and navigate to a review input area of the site, if there is one, and then post a review. Such is not an enjoyable process and consequently only reviewers with a reason to endure the steps will generally do so. Generally, such reviews tend to be bad since the reviewer is driven by anger to navigate the many steps to post it.

Still further, even where a potential ticket buyer for a concert, or a festival, or dance event is able to find a reliable review on the artist, the music, or the venue for an upcoming event, there is no way currently to ascertain if the potential ticket buyer's friends plan to attend the event. Neither is there a manner for the attendee to ascertain where attending friends might be staying if the venue is out of town, and how those friends and acquaintances might be traveling to such an out of town venue. All such information which can directly influence the potential ticket buyer's propensity to purchase the event tickets, as well as their hotel reservations and plane or train tickets for transportation.

Finally, even with conventional online and telephonic ticket sales providing venue access and seating with tickets, they fail to provide any ability for the traveling-buyer who may be going across town, or across the country, to actually transport themselves to the venue. Such is left for the buyer to research or just to try to find public transportation to the venue from an airport, train station or their home.

As such, there exists an unmet need for a system providing ticket sales for buyers planning to attend an electronic music dance event or festival, a live music concert or live music dance event, an artistic show, or any event at a venue where the members of the crowd attending, should they be friends or acquaintances of the potential ticket buyer, will influence the sale of the ticket to the potential buyer in real time. Such a network-enabled system should endeavor to provide reliable reviews from actual attendees of such events and venues to provide reliable review information to friends and acquaintances of that reviewer. Such a system should provide push notifications to friends and acquaintances of a potential ticket buyer to an event or venue, that their friend is planning to attend the event or venue to help sell more tickets to friends. Such a system should provide an easier manner to communicate entry tickets to subscribers to the system as well as means to automatically notify attendees of an event, upon the arrival at a venue of their friends. In providing such a system, it will enhance the overall experience of subscribers by increasing crowd members attending who are friends and acquaintances of the subscribing attendee.

Additionally, such a system should endeavor to not only provide socially-networked individuals who are friends with information of fellow members upcoming attendance at an event or venue, the system should also provide socially-networked members or subscribers with tangent information to the actual venue or event such as hotel accommodations for fellow members and travel plans, to allow more associated members and friends to travel and stay together prior to and after the event, to enhance the experience.

Still further, such a system should endeavor to encourage reviews by subscribing members to thereby provide event, artist, and venue reviews, from actual verified attendees of prior events at such venues. Such reviews should not only be available to third parties in considering future purchases, they should be available to friends and acquaintances of the reviewer so as to provide them a known insight from a trusted source of information. Finally, such a system should endeavor to encourage such timely reviews of previous events, venues, and performers and music providers, through a reward system where verified ticket purchasers are provided a reward related to their interests, subsequent to submitting a set number of reviews.

Finally, in addition to providing the above, such a method and system should also endeavor to provide users tangent venue information and even reservations with transportation providers such as UBER, LYFT, and ZIPCAR, to actually get themselves to the venue, either locally or when traveling a long distance to attend. Such should be provided concurrently with or subsequent to ticket purchase which may encourage such by removing an impediment to attending.

The forgoing examples of related art and limitations and shortcomings related therewith, are intended to be illustrative and not exclusive, and they do not imply any limitations on the invention described and claimed herein. Various limitations of the related art are, or will become apparent to those skilled in the art upon a reading and understanding of the specification below and the accompanying drawings.

### SUMMARY OF THE INVENTION

The disclosed system and method provides for the enhanced sale of tickets for concerts, dance events, festivals, and other ticketed events where a crowd will attend and watch and/or participate. Employing the system herein, subscribing members who attend an event can affect their own enjoyment of the event itself through a networking of ticket purchases and event plans communicated to friends and acquaintances of subscribing buyers.

Employing software running on a network-accessible computer or server, the system will provide for software enabled sale of tickets to buyers planning to attend an upcoming event at a particular venue. Such events can include but are not limited to electronic music dance events, music or dance festivals, a live music concert or live music dance event, an art show or film festival or any event at a venue where a crowd will watch and/or participate in the actual event.

Concurrent with online ticket sales for future events, the system employing software adapted to the task of review intake and posting, will also provide verified reviews from previous attendees of a particular event, venue, group, or performer, or the like, through the posting of reviews which are input electronically. To encourage such review input, reviewing subscribing system members who are cross-matched as verified attendees of the event or artist they review, will be given a gift or other enhancement upon the completion of a determined number of reviews.

The system will employ software configured for social networking to electronically communicate to friends and acquaintances provided the system by the subscribing ticket buyers, a notice of their intent or plan to visit a particular venue, or attend a particular concert or dance festival, or other event. Subscribing users will, by inputting contact information for their friends and acquaintances, which are held in electronic memory in a relational database associated with the subscriber, allow the system to notify such friends and acquaintances of an upcoming event and/or venue which will or may be attended by the subscribing purchaser.

This communication of ticket planning or purchase to friends provides a means to enhance the experience of both the subscribing ticket buyer and the associated friends. Such an enhancement, as noted, occurs by increasing the number of friends and acquaintances who concurrently attend the event, due to the notification sent in advance to related friends, based on one or a plurality of associated friends purchasing tickets.

Further, the system will allow ticket purchasers to also input travel information or plans for the upcoming event and venue, such as hotels, airline flights, restaurants, and other information which related members plan to use. Again, this information by automatically being communicated to authorized friends and acquaintances of the original and subsequent ticket buyers, by the software of the system adapted to do so, will allow all attendees to travel together, stay together, and attend the event together, due to the notifications sent by the system.

Additionally, the system can facilitate this enhanced travel and hotel stay, and restaurant use, and other related travel requirements to a venue or event, by offering related buyers reservations at the same hotel, on the same airline or flight, and for instance reservations at the same restaurant in the same time frame as other related individuals identified as friends.

The system can operate its own social networking site using software adapted to ascertain input related individuals, and authorizations to communicate therewith using provided electronic communications by the subscriber, such as the email address of friends and acquaintances. Alternatively, the system can use contact formation of the subscribing members for their friends on existing social networking sites such as FACEBOOK.

In either fashion, a subscribing member will input their contact information online over a network, such as the internet, and will subsequently be provided with screens to input identification and contact information for friends and acquaintances. This input information with friends and acquaintances can also be categorized by interest, event, venues, or other parameters set by the subscribing user, to relate each respective identified friend with the subscribing user and their respective common interests which the subscribing user identifies as that which should elicit a communication when the subscribing user purchases a ticket or inputs an interest in attending a future event, concert, venue, dance festival, dance club, or the like.

Thereafter, when a subscribing user inputs an interest in attending a future event, or buys a ticket for such, the previously identified friends and acquaintances will be notified and may be given electronic links to purchase tickets for the same event, or related travel purchase thereto. Subsequent purchasers who are also subscribers will have their respective identified friends and acquaintances notified, who also may be given electronic links in the notification to purchase event tickets and/or related travel services.

Still further, the system herein can be enabled by current members of social networking sites, such as FACEBOOK, by an opt-in page or communication from the member at that site, wherein their contact information and associated friends and acquaintances on the pre existing social networking site, can be communicated to the system provider herein, and employed subsequently for communications concerning the member's upcoming attendance at an event or venue.

Finally, the system herein is also configured with software adapted to employ databases of stored information concerning transportation, to provide users information, and even reservations, with transpiration providers such as UBER, LYFT, and ZIPCAR. Such information and/or reservations can be provided concurrent with a user researching or buying a ticket for attendance or may be pushed electronically subsequent to such a purchase since the system will know the ultimate location for the venue, and starting point of the buyer, and using software adapted to cross match available transpiration between the starting point and venue site, be able to provide such information and interconnection.

Still further, in a particularly preferred mode of the system herein, subscribing users will be provided with subscriber cards which are encodeable electronically using a microchip, RFID, or mag-strip. The subscriber cards can function as a ticket to the venues attended by the subscribing user through the provision of electronic lists of ticket buyers associated with the ticket buyer's subscriber card. Upon arrival at a venue, the card is swiped at a kiosk or swipe site, to provide the holder entry as a ticket. Concurrently, the swipe of the attendee's card through the kiosk or reader will validate the actual attendance of the card holder to cross reference such with any reviews input by that card holder to verify the review. Finally, the subscriber card, once swiped at a kiosk or swipe site at the venue, can serve to initiate electronic communications, to known friends of the card holder, that they have arrived at the venue. While such conventionally may be handled by the user using text messaging on a cell phone, using the system, all known friends known to be at the venue will be concurrently notified with a simple card swipe. Finally, should the user lose their cell phone the system can allow the user to employ a swiping of the subscriber card, to notify friends of that fact, and the card holder's location.

In this manner, prospective purchasers of tickets from the service for events, venues, artist performances, and the like, will have access to reliable reviews, and, the purchasers of tickets from the system which has identified friends and acquaintances, and will have those friends and acquaintances notified their friend is attending and they may be given links to purchase tickets and travel to accompany them. All may use subscriber cards as tickets at the venue, as well as a trigger to cause the system to notify known attending friends and acquaintances, of the arrival of the card holder at the venue.

In this respect, before explaining at least one embodiment of the device and method herein in detail, it is to be understood that the invention is not limited in its application to the details of the method set forth in the description herein. The invention is thus capable of other embodiments and of being practiced and carried out in various ways and in different orders of execution. Also, it is to be understood that the phraseology and terminology employed herein are for the purpose of description and should not be regarded as limiting.

As such, those skilled in the art will appreciate that the conception upon which the system for the sale of event tickets to subscribers which will subsequently notify identified contacts of such, may readily be utilized as a basis for the designing of other methods for carrying out the purposes of the present invention. It is important, therefore, that the claims be regarded as including such equivalent construction insofar as they do not depart from the spirit and scope of the present invention.

It is an object of this invention to provide a network accessible software-enabled system providing a method of selling tickets to attendees of musical, art, and other events and venues.

A further object of this invention is the provision of such a system for ticket sales, which encourages verified reviews by providing rewards to attendees for subsequently providing such reviews of the event or venue.

Yet another object of this invention is the provision of such a ticket selling system which endeavors to enhance the buyers experience by notifying friends and acquaintances who might also attend.

A still further object of this invention is to provide local transportation information using social transportation services such as UBER and LYFT which will aid the subscriber in purchase decisions as well as transport to a venue.

An additional object of this software enabled method, is to provide users with electronically encodeable subscriber cards which may function as actual venue tickets, as well as provide a means to trigger messaging to the card holder's friends of their arrival at a venue.

These together with other objects and advantages which will become subsequently apparent reside in the details of the construction and method as more fully hereinafter described and claimed, reference being had to the accompanying drawings forming a part thereof, wherein like numerals refer to like parts throughout.

With respect to the above description then, it is to be realized that the optimum relationships for the method, software and hardware herein are to include variations in function and manner of operation, steps in operation and use, which are readily apparent and obvious to one skilled in the art, and all equivalent relationships as would occur to those skilled in the art on review of such illustrated in the drawings and/or described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF DRAWINGS

FIG. 1 is a graphic depiction of a flow chart of a simplified mode of operation of the computer-enabled network accessible system herein.

### DETAILED DESCRIPTION OF PREFERRED EMBODIMENTS

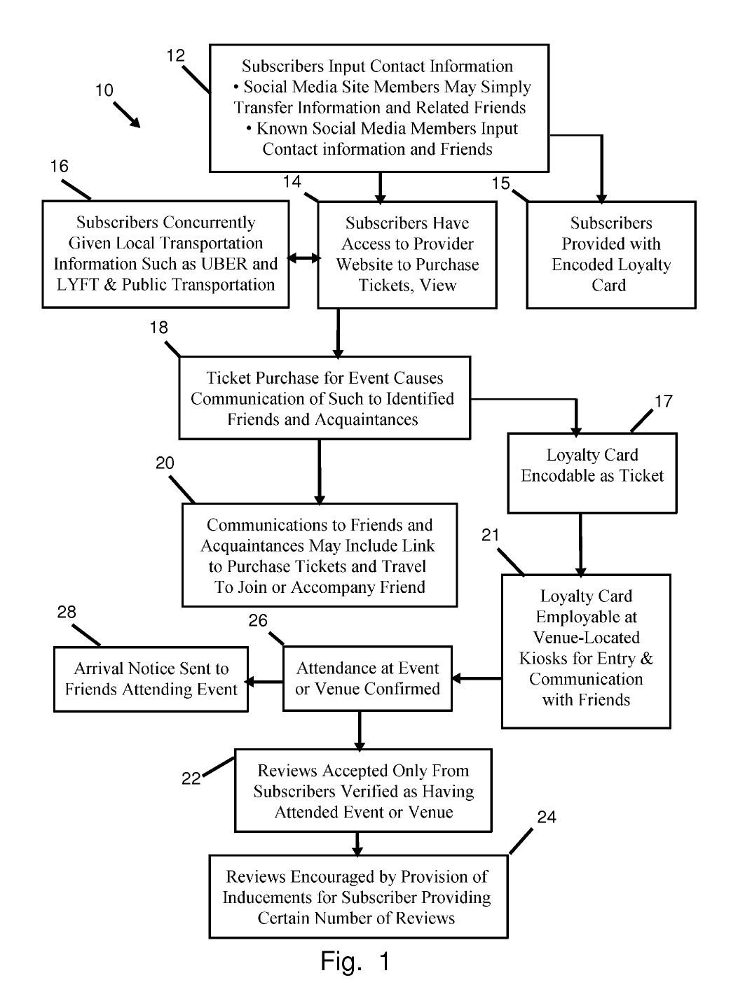

Referring now to the drawings of FIG. 1 some preferred embodiments of the present invention in current preferred modes of the system 10 are shown and described.

In operation, the method and system 10 herein employs software running on a network accessible computer or server to provide a graphic interfaces and depictions to subscribers to implement the various steps and actions.

In a first step, subscribers to the system 10 will be provided with a graphic interface to input information in fields to register 12 as subscribing members. In doing so the users will input contact information and will provide at least some other information concerning one or more association points such as their music, travel, and other affinities, as well as other information such as credit card or bank payment information or PAYPAL links.

Users may also register 12 or provide association points for the system by voluntary communication of information from social networking sites such as FACEBOOK, or other commerce sites such as AMAZON PRIME. In doing so, a user information file includes the user's friends, electronic communication addresses thereof, their interests, and other information employed by the system in a relational database associated with the user, may be input for later use in notifying such friends or communicating with the user concerning an event discerned by software adapted to relating user interests or noted group or venue affinities, to events or concerts or the like which encompass such.

Also subsequent to registration 12, the subscribing user may be provided subscriber cards which are encodeable electronically using a microchip, RFID, or mag-strip. The subscriber cards can function as a ticket 17 to the venues or events for which tickets are purchased by the subscribing user.

Once users register 12 and are a registered subscriber with an associated user information file, users of the system 10 will have access to provider websites, and communicated graphic interfaces concerning such which will be linked to or communicated from the system provider server 14. With this network access subscribing users may view event or venue reviews, purchase tickets. Additionally, while viewing the site of the system provider server 14, subscribing users can have potential purchases for tickets for events pushed to them as pop ups, or other graphic depictions on the screen, when an artist, event, or venue for which the subscribing user has a known affinity, comes available.

Concurrent with researching and purchasing venue and event tickets, subscribing users may be given information concerning, or the opportunity to secure, transpiration 16 to a venue locally or in a remote location which might require travel and local transportation. This is implemented using the software running on the system which is adapted to cross reference the known subscribing user starting location, and their required destination based on the ticket purchased, with transportation providers in the database which service such a route.

Such transportation information can then be provided through links with social transportation such as UBER, LYFT, ZIPCAR, and other potential providers of transportation across town, or providers know to provide transportation from an anticipated airport, hotel, or other remote starting point, to a venue for which the subscribing user purchased a ticket for attendance.

As noted earlier, upon a ticket purchase on the system provider server 14 for a particular venue or event, a message 18 of such may be communicated to subscribing user previously-identified friends and acquaintances which are associated with the subscriber in their user information file stored electronically. Such will allow others whose company the subscribing user is known to enjoy, to also purchase tickets or communicate with the subscribing user concerning the upcoming event or venue visit.

This electronic communication to friends and acquaintances, using text messaging or email, or other electronic means for messaging, may also include an actual HTML link 20 therein to a webpage hosted by the provider server 14 to allow the identified known friends to purchase tickets for seats which might be close in proximity to the subscribing user who already purchased, or at the same venue.

Additionally, because the system has electronically stored the home location and the venue location for tickets purchased, should attendance at the venue or event require travel, the subscribing user and identified friends may be offered html links to webpages hosted on the provider server 14 allowing for purchasing of the same hotel, plane rides, train tickets, and local transport by UBER or other social transport services. With the subscribing user and identified friends staying and traveling together it may make the visit to the venue or event more enjoyable for all, since as noted, enjoying attendance at a venue or event with friends is not just affected by concurrently attending the venue or event, but is enhanced by what occurs before and after the event.

Upon purchase of a ticket from the communicated graphic interface or webpage from the provider server 14, as noted, the subscriber card can be encoded or cross referenced to the user and their payment, to function as a ticket for the venue or event 17. This of course avoids the previously mentioned pitfalls of mail delivery and picking up a ticket at the venue and I.D. and credit card requirements.

Further, upon arrival at a venue, the card may be swiped at a through an electronic card reader at a kiosk or swipe site 21, and communicate to the provider server 14 over the network that the subscribing user associated with the subscriber identification on the subscriber card, has arrived at the venue, as well as functioning as a ticket to allow the venue personnel to admit the subscribing user based on an affirmative electronic communication to the venue that the card holder is a ticket holder.

The system 10 will also employ the electronic communication from the venue, of the physical or electronic swipe of the attendee's subscriber card through the kiosk or electronic reader, to confirm 26 the actual physical attendance of the identified subscriber card holder at the venue. Such can later be cross-referenced with input reviews from attendees, to confirm only reviews from actual attendees are hosted or displayed on the related webpages communicated to future users from the providers server 14.

In an additional step, the system can employ the communication of the card swipe of the known user associated with the subscriber card, as a trigger to initiate electronic communications to known friends of the card holder 28, of the arrival of the subscribing member associated with the subscriber card, at the venue. Thus, friends identified by the subscribing user and held in their respective user file, subsequent to the subscriber card swipe, will be sent emails, text messages, or other electronic communications notifying them a friend has arrived and is at a particular location associated with the card reader at a kiosk or swipe-site at the venue, to allow them to meet-up easily.

In an effort to maintain credibility of the provider site, reviews input subsequent to an event, or venue attendance, are allowed for publication subsequent to input, only from known subscribers 22 who have been electronically verified such as by a subscriber card swipe 26 as physically attending the event or venue being reviewed. The system may also employ a database to cross match attendance information from venue providers who are members, to subscribing members who are inputting reviews, verifying they have attended what they are attempting to review. In this fashion the resulting reviews will be reliable to those who follow the system 10.

Finally, in a particularly preferred step, the system 10 will take actions to encourage such review input from registered subscribing users, by the provision of inducements 24 to those subscribers who make the effort and take the time to input a review of a venue, event, artist, food, movie, or other reviewable information. After a determined number of input reviews an inducement 24 is awarded which can be any one or a plurality of inducements from a group of inducements including, a discount on a said ticket purchase, a free said ticket to a future said event, a discount coupon for merchandise, and electronic music recordings or other rewards which will encourage honest reviews from subscribing users who are verified as having attended a particular event or venue.

As such, in the above fashion, subscribing users will be provided information and opportunity to visit and attend venues and events to which they have an affinity, they will enjoy it more fully since friends will be encouraged to join them, they will be afforded the convenience of a subscriber card which can function as a notification trigger as well as a ticket, and all subscribing users will be afforded honest reviews of venues and events and artists and other information relevant to a ticket purchase or future venue attendance, though the knowledge that all such reviews are verified reviews from other subscribing members.

The system shown in the drawings and described in detail herein disclose arrangements steps and provision of services in a particular configuration for illustrating preferred embodiments of current networked computer enabled systems. It is to be understood, however, that elements of different configuration, and using different steps and process procedures, and other arrangements thereof, other than those illustrated and described, may be employed for an engine system in accordance with the spirit of this invention.

As such, while the present invention has been described herein with reference to particular embodiments thereof, a latitude of modifications, various changes and substitutions are intended in the foregoing disclosure, and will be appreciated that in some instance some features of the invention could be employed without a corresponding use of other features, without departing from the scope of the invention as set forth in the following claims. All such changes, alternations and modifications as would occur to those skilled in the art are considered to be within the scope of this invention as broadly defined in the appended claims.

What is claimed is:

1. A system for social networking, reviews, and purchases, enabled by software running in electronic memory on a network engaged computer which is electronically accessible to subscribers thereto, comprising the steps of:
providing a network accessible website operating with software running on a system provider computing device configured for electronic communication with current subscribers, and with potential subscribers of said social network;
communicating to said potential subscribers, over said network, a graphic interface displayable on a video display of a computing device of said potential subscribers, said graphic interface employable to input personal information and thereby register as subscribers to said social network;
providing a graphic interface accessible by said subscribers to input respective personal interest information which is associated with said personal information for each respective said subscriber;
providing a graphic interface accessible by said subscribers for input of respective individual friends and input of respective electronic contact information associated with each respective said friend, as part of said personal information for each respective said subscriber;
electronically storing respective said personal information in a respective user information file in a database in relation with each respective subscriber inputting said personal information;
providing a graphic interface accessible by each said subscriber, configured to allow a purchase of a ticket for an event requiring a said ticket for attendance;
subsequent to any said purchase of a ticket by a said subscriber, electronically storing purchase information concerning each said purchase of a said ticket to a said event, in a respective said user information file relating to said subscriber purchasing said ticket; and
subsequent to a said purchase of a ticket by a said subscriber, communicating an electronic message to said friends identified in said user information file associated with said subscriber purchasing said ticket, informing said friends that said subscriber has purchased a said ticket to said event, whereby, said friends of said ticket-purchasing subscriber, are provided information concerning an upcoming said event which a said subscriber they are associated with plans to attend as an inducement to purchase a said ticket to said event to join said ticket-purchasing subscriber.

2. The system of claim 1 additionally comprising the steps of:
including a hyperlink in said message to said friends of said subscriber who has purchased a ticket, which is executable on a computing device of a said friend receiving said message, to cause a browser running thereon to navigate to a graphic interface configured to allow said friend to purchase a said ticket for said event, which was previously purchased by said ticket-purchasing subscriber.

3. The system of claim 1 additionally comprising the steps of:
providing a graphic interface accessible over said network only by said subscribers which is configured for an input of a review of a said event by a said subscriber; and
subsequent to a said input of a said review of a said event, by a subscriber, reviewing said user information file relating to said subscriber inputting said review, to ascertain a confirmation from said information relating to each said purchase of a said ticket stored therein, that said subscriber inputting said review, purchased a said ticket to said event being reviewed.

4. The system of claim 2 additionally comprising the steps of:
providing a graphic interface accessible over said network only by said subscribers which is configured for an input of a review of a said event by a said subscriber; and
subsequent to a said input of a said review of a said event, by a subscriber, reviewing said user information file relating to said subscriber inputting said review, to ascertain a confirmation, from said information relating to each said purchase of a said ticket stored therein, that said subscriber inputting said review, purchased a said ticket to said event being reviewed.

5. The system of claim 3 additionally comprising the steps of:
tracking a total number of said reviews input by each respective said subscribers; and
tendering to any said subscriber inputting a determined said total number of said reviews, one or a plurality of inducements from a group of inducements including, a discount on a said ticket purchase, a free said ticket to a future said event, a discount coupon for merchandise, and electronic music recordings.

6. The system of claim 4 additionally comprising the steps of:
tendering to any said subscriber, inputting a determined said total number of said reviews, one or a plurality of inducements from a group of inducements including, a discount on a said ticket purchase, a free said ticket to a future said event, a discount coupon for merchandise, and electronic music recordings.

7. The system of claim 1 additionally comprising the steps of:
providing each said subscriber with an electronically readable subscriber card having at least an identification of said subscriber electronically stored thereon;
positioning electronic card readers for said subscriber cards at a venue hosting a said event, which are encoded to identify said venue location;
allowing said subscribers attending said event at said venue to employ said card reader to electronically read said identification of said subscriber therefrom;
upon a reading of a said subscriber card by a said electronic card reader, communicating over said network to said system provider computing device said subscriber identification electronically read from said subscriber card, as a verification of physical attendance at a said event at said venue location;
inputting said verification of attendance of said subscriber to said respective user information file relating to said subscriber having said subscriber identification.

8. The system of claim 3 additionally comprising the steps of:
providing each said subscriber with an electronically readable subscriber card having at least an identification of said subscriber electronically stored thereon;
positioning electronic card readers for said subscriber cards at a venue hosting a said event, which are encoded to identify said venue location;
allowing said subscribers attending said event at said venue to employ said card reader to electronically read said identification of said subscriber therefrom;
upon a reading of a said subscriber card by a said electronic card reader, communicating over said network to said system provider computing device said subscriber identification electronically read from said subscriber card, as a verification of physical attendance at a said event at said venue location;
inputting said verification of attendance of said subscriber to said respective user information file relating to said subscriber having said subscriber identification; and
employing said verification of attendance as said confirmation said subscriber purchased a said ticket to said event being reviewed.

9. The system of claim 7 additionally comprising the steps of:
subsequent to a communication over said network of said subscriber identification encoded to said subscriber card, communicating an electronic message to said friends identified in said user information file associated with said subscriber identified by said subscriber identification, that said subscriber has arrived at said venue and is currently proximate to said card reader, whereby said friends associated with said subscriber employing said card reader can locate said subscriber at said venue.

10. The system of claim 7 additionally comprising the steps of:
associating a said subscriber card having said identification identification of a said subscriber electronically stored thereon, with a said ticket purchased by said subscriber using said graphic interface configured to allow a purchase of a said ticket for a said event; and
employing said subscriber card as a said ticket upon said reading of said card by said electronic card reader.

11. The system of claim 8 additionally comprising the steps of:
associating a said subscriber card having said identification of a said subscriber electronically stored thereon, with a said ticket purchased by said subscriber using said graphic interface configured to allow a purchase of a said ticket for a said event; and
employing said subscriber card as a said ticket upon said reading of said card by said electronic card reader.

12. The system of claim 9 additionally comprising the steps of:
associating a said subscriber card having said identification of a said subscriber electronically stored thereon, with a said ticket purchased by said subscriber using said graphic interface configured to allow a purchase of a said ticket for a said event; and
employing said subscriber card as a said ticket upon said reading of said card by said electronic card reader.
